(19) United States
(12) Patent Application Publication
(10) Pub. No.: US 2026/0024191 A1
(43) Pub. Date: Jan. 22, 2026

(54) AI-BASED PRINTED CIRCUIT BOARD INSPECTION SYSTEMS AND APPLICATIONS

(71) Applicant: NVIDIA Corporation, Santa Clara, CA (US)

(72) Inventors: Shaunak Gupte, Dombivli(W) (IN); Tushar Khinvasara, Pune (IN); Amit Kale, Pune (IN); Jitendra Kumar, Gurugram (IN); Prasad Prakash Nikam, Pune (IN); Viranjan Pagar, Pune (IN); Rithik Verma, Jammu (IN); Stephen Heidelberg, Glendora, CA (US); Bhushan Rupde, Pune (IN); Kaustubh Purandare, San Jose, CA (US)

(21) Appl. No.: 18/778,610

(22) Filed: Jul. 19, 2024

(51) Int. Cl. G06T 7/00

(52) U.S. Cl. CPC G06T 7/001; G06T 2200/24; G06T 2207/20081; G06T 2207/30141

(57) ABSTRACT

In various examples, a microservices-based architecture may be configured to detect, analyze, and/or reduce instances of PCB defects using AI-based models and other algorithms. For instance, image data representing an image of a PCB may be applied to a model running within a first service associated with an application. The model may process the image data to generate one or more predictions relating to defects associated with the PCB. In some instances, one or more second services associated with the application may use the predictions to generate visualizations and/or compute metrics corresponding to the defects associated with the PCB. Additionally, in some examples, the predictions, the visualizations, and/or the metrics may be used to update one or more parameters associated with one or more systems to, for instance, improve the performance of AOI systems, SMT systems, or any other systems.

### BACKGROUND

Automated Optical Inspection (AOI) and/or similar technologies may be used in electronics manufacturing to inspect printed circuit boards (PCBs), electronic assemblies, and/or other components for defects. For example, an AOI system may use cameras, lighting systems, and computer algorithms to automatically detect various types of defects associated with PCBs, such as missing components, incorrect components, misalignment, soldering defects, and potentially other issues that may affect the functionality or reliability of the PCBs. As such, AOI systems may help manufacturers ensure quality control and improve the efficiency of the inspection process.

However, AOI machines still require human operators for various tasks throughout the inspection process. For example, while an AOI machine is running, operators may monitor the AOI machine to ensure correct functioning and potentially intervene if issues arise during the inspection process. Additionally, AOI machines may detect anomalies that require human judgment (e.g., to determine whether anomalies are actual defects or false positives), and human operators may review inspection results and make final decisions. Because of this, AOI inspection processes suffer from various inefficiencies and may also be prone to human error.

Additionally, while AOI machines may be beneficial for inspecting PCBs during manufacturing and improving quality control, AOI systems are generally limited to their use in the manufacturing context. As such, if a PCB becomes defective after being sent to market or after being deployed for its intended use, AOI systems may not be readily available to diagnose these developed defects. Furthermore, tracking defects after a PCB has entered the market can be difficult, as well as using information learned from defects developed in deployment to make subsequent remedial improvements to the manufacturing and/or design of the PCB.

### SUMMARY

Embodiments of the present disclosure relate to artificial intelligence (AI)-based printed circuit board (PCB) inspection systems and applications. Systems and methods are disclosed for, among other things, detecting, analyzing, and reducing instances of PCB defects using machine learning and/or other AI-based models and algorithms. For instance, image data representing an image of a PCB may be applied to a model running within a first service associated with an application. The model may process the image data to generate one or more predictions relating to defects associated with the PCB. In some instances, one or more second services associated with the application may use the predictions to generate visualizations and/or compute metrics corresponding to the defects associated with the PCB. Additionally, in some examples, the predictions, the visualizations, and/or the metrics may be used to update one or more parameters associated with one or more systems to, for instance, improve the performance of AOI systems, Surface Mount Technology (SMT) systems, or any other systems.

In contrast to conventional systems, such as those described above, the systems of the present disclosure, in some embodiments, are able to automatically detect PCB defects using machine learning models to process images of PCBs. In this way, the systems of the present disclosure may be used as a secondary inspection measure to validate AOI machine outputs, thereby increasing the efficiency and accuracy of PCB inspection processes. Additionally, in contrast to the conventional systems, the systems of the present disclosure, in some embodiments, may classify PCB defects and maintain metrics for various defects with respect to various PCBs, components, soldering, or other aspects. In this way, the systems of the present disclosure may provide more context related to PCB defects, as well as be able to troubleshoot and/or remedy AOI system errors and/or manufacturing-related errors (e.g., SMT errors) leading to certain PCB defects.

### BRIEF DESCRIPTION OF THE DRAWINGS

The systems and methods for AI-based printed circuit board (PCB) inspection systems and applications in the present disclosure are described in detail below with reference to the attached drawing figures, wherein:

FIG. 1 is a data flow diagram illustrating an example process that may be performed by a microservice-based PCB inspection system, in accordance with some embodiments of the present disclosure;

FIG. 2 illustrates an example of the PCB inspection system converting input data into a desired format, in accordance with some embodiments of the present disclosure;

FIG. 3 illustrates an example of a data control service obtaining input data stored in a data base by a management service, in accordance with some embodiments of the present disclosure;

FIG. 4A illustrates an example of the data control service applying image data to multiple inference services, in accordance with some embodiments of the present disclosure;

FIG. 4B illustrates an example of an inference service processing image data to generate predictions, in accordance with some embodiments of the present disclosure;

FIG. 5 illustrates an example of an overlay service generating a visualization based on predictions, in accordance with some embodiments of the present disclosure;

FIG. 6 illustrates an example graphical user interface for displaying information associated with PCB defects, in accordance with some embodiments of the present disclosure;

FIG. 7 is data flow diagram illustrating an example end-to-end process associated with inspecting a PCB for defects, in accordance with some embodiments of the present disclosure;

FIG. 8 is a flow diagram illustrating an example method for using services of a microservice-based architecture to analyze and display information relating to predicted PCB defects, in accordance with some embodiments of the present disclosure;

FIG. 9 is a flow diagram illustrating an example method for updating parameters of a machine based on PCB defects, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods disclosed herein relate to AI-based printed circuit board (PCB) inspection systems and applications. In some examples, a system(s) may implement an application for, among other things, detecting, analyzing, and/or reducing instances of PCB defects. As described herein, the system(s) may be used as a secondary inspection system(s) to an automated optical inspection (AOI) machine(s). Additionally, or alternatively, the system(s) may be used as an independent, standalone PCB inspection system for analyzing PCB defects for PCBs outside of the manufacturing context. The system(s) may provide additional context related to PCB defects, as well as be able to correlate PCB defects for troubleshooting and/or remedying errors associated with AOI systems, manufacturing systems, PCB components, and/or any other systems or components related to PCB technology.

As described herein, the system(s) may use AI-based models—such as machine learning models, neural networks, or any other models—and/or classical processing algorithms, in some examples, to perform various operations on behalf of the application. For instance, the system(s) may use the AI-based models or other algorithms to perform operations including, but not limited to, inspecting PCBs, analyzing defects, computing metrics, generating visualizations, troubleshooting causes of PCB defects, troubleshooting AOI machine errors, modifying AOI machine parameters, and modifying manufacturing system parameters. As one example, the systems(s) may use a combination of machine learning models and classical algorithms to process image data and predict defects associated with PCBs. As another example, the system(s) may analyze PCB defects detected or undetected by an AOI machine and alter parameters of the AOI machine to improve its operation. For instance, if the AOI machine is making false-positive and/or false-negative predictions, the system(s) may identify the cause of those errors and alter AOI parameters accordingly. Additionally, or alternatively, the system(s) may analyze PCB defects and identify root causes of the defects, such as faulty components, faulty manufacturing, etc., and take steps to reduce the defects.

In some examples, the models, algorithms, and/or other processes described herein may be executed within one or more independently deployable services (also referred to herein as “microservices”). For instance, the microservices may be packaged along with their runtime environments, dependencies, libraries, and configuration files into a container image that includes information needed to run the microservices consistently across different environments. The containerized microservices may be deployed onto one or more container orchestration platforms that manage the lifecycle of the containers, including deployment, scaling, and/or monitoring. The container images may be deployed onto one or more host machines of the container orchestration platforms. Additionally, or alternatively, various other infrastructure types may be used to deploy the system(s) disclosed herein. For instance, the system(s) may be deployed using virtual machines, serverless computing platforms, Platform-as-a-Service (PaaS) systems, on-prem and/or cloud-delivered computing devices (e.g., traditional hosts), edge computing platforms, a combination thereof, or any other infrastructure systems in addition to containers, or in the alternative thereof.

In some instances, the system(s) may include or use a data management service to manage data that is uploaded to the system(s) for analysis. The data management service may provide support for uploading and/or downloading the data to/from the system(s). Additionally, the data management service may support aging policies to manage disk space occupied by the data, as well as support retrieval of images containing visualizations of inspection results, among other things. The data management service may store the data used and/or generated by the system(s) in one or more databases. As described herein, the data may include, among other things, image data representing images of PCBs, cropped images of PCB defects (e.g., an image of a portion of the PCB), images of PCB components, or any other images. Additionally, the data may include textual data indicating, for instance, information associated with a PCB and/or the image data—such as a serial number or other identifier associated with the PCB, whether the PCB is in the manufacturing or post-manufacturing context, etc.—information associated with an ROI machine that pre-inspected the PCB, information associated with the manufacturing process of the PCB, such as SMT machine or other assembly equipment information.

In various examples, the system(s) may include or use a data control service for controlling various aspects of execution. For instance, the data control service may send inference requests to one or more inference service(s) to process newly uploaded data. That is, the data control service may send requests to the inference services and/or apply the data (e.g., image data) to the inference services so that the inference services may analyze the data and make predictions relating to PCB defects, etc. Additionally, the data control service may send overlay (e.g., visualization) requests for data on which inference has been performed. That is, the system(s) may send requests to, for instance, an overlay service and/or a visualization service to generate visualization data (e.g., images, graphs, statistics, etc.) associated with predictions made using the inference service. The data control service may also manage the state of the various inference requests in the database(s) and save inference results in the database(s) so that the results may be queried later.

In some examples, the system(s) may include or use an inference service to make predictions regarding PCB defects. For instance, the system(s) may apply image data representing an image of a PCB or a portion of the PCB to the inference service, and the inference service may generate one or more predictions relating to one or more defects associated with the PCB. The inference service may include or use one or more machine learning models and/or classic image processing algorithms to process the data and detect the defects associated with the PCBs. For instance, the system(s) may apply, to one or more machine learning models executing within the inference service, image data representing an image of at least a portion of a PCB. Based on the application of the image data to the machine learning model(s), the system(s) may obtain output data indicating at least one or more defects associated with the PCB.

In some examples, the system(s) may include one or multiple instances of the inference service. For instance, the system(s) may include a suite of inference microservices (and/or traditional services/applications) for various kinds of defect detections. As an example, the system(s) may include one or more first inference microservices for identifying missing components of a PCB, one or more second inference microservices for identifying incorrect components on a PCB (e.g., component “A” instead of component “B”), one or more third inference microservices for identifying SMT defects, steel surface defects, soldering defects, etc., and so forth. However, these are just a few examples, and the system(s) may include inference services for making any kind of inferences related to PCB technology, AOI technology, SMT placement machine technology, or other technologies.

The system(s) may include or use, in some instances, an overlay service to visualize the results of inference. For instance, the system(s) may apply at least a portion of the output data from the inference service to the overlay service, and the overlay service may generate visualization data indicating information associated with the one or more defect associated with the PCB. In at least some examples, the overlay service may modify or update the original image data to draw locations of defects and/or descriptive text on the image of the PCB. For instance, if a defect is detected for a specific component of multiple components of the PCB, the image of the PCB may be modified with a box, arrow, or some other visual indication to indicate the location of the specific component that is defective. Additionally, or alternatively, the image of the PCB may be modified with textual data describing the defect (e.g., solder defect, wrong component, misalignment, component failure, etc.).

In some examples, the system(s) may include or use a visualization service to visualize the results of the inference and/or overlay services. The visualization service may use one or more dashboards to present a user interface indicating results of the inference, overlay data, or any other data that may be stored in the database(s) used by the system(s). For instance, the visualization service may visualize various defects of individual PCBs. Additionally, or alternatively, the visualization service may visualize various metrics associated with the defects, such as number of defects second, average defects per PCB, distribution of various kinds of defects, PCB models with highest number of defects, frequencies of defect types per PCB, or any other metrics. The metrics may be visualized by the visualization service using charts, graphs, images, text, text-to-speech, or any other means of conveying the information.

As described herein, the system(s) may, in various examples, use the predictions, the visualizations, and/or the metrics to update one or more parameters associated with various PCB-related manufacturing systems. For instance, the system(s) may use one or more of the predictions, the visualizations, and/or the metrics to identify errors associated with PCB-related systems, such as AOI machines and systems, SMT machine and systems, or any other systems. As an example, based at least on metrics indicating an AOI machine is producing a number of false-positive or false-negative detections that meets or exceeds a threshold (e.g., 5 misdetections per board, 100 misdetections per day, etc.), the system(s) may alter one or more parameters associated with the AOI machine to improve its performance and reduce the number of misdetections. As another example, based at least on visualizations and metrics indicating that PCBs produced by a certain SMT machine include a number of defects that meet or exceed a threshold (e.g., 5 defects per PCB, same defects for number of PCBs, etc.), the system(s) may alter parameters of the SMT machine to improve its performance, temporarily shut down the SMT machine, or perform any other operation responsive to the defects exceeding the threshold. As yet another example, if metrics continuously indicate a failure of a certain component of a PCB that is in market, the system(s) may propose changes or alternative components to replace the problematic components. While these are just a few examples, the system(s) described herein may perform any number and/or type of operations to improve PCB-related technology based on detecting and analyzing PCB defects.

In some examples, the individual services (e.g., microservices) used by the system(s) may expose their functionality using Representational State Transfer (REST) Application Programming Interfaces (APIs). In this way, clients may invoke the REST APIs to interact with the services/applications of the system(s). For example, there may be REST APIs to perform various operations including, but not limited to, uploading PCB images and associated metadata (e.g., PCB serial number, etc.), triggering inference requests (e.g., defect detection) on the PCB images, and retrieving results of inference requests. In some examples, the clients accessing the system(s) may be command line interface (CLI) based—such as simple curl commands—or Python based client applications that provide advanced functionality. Additionally, or alternatively, the clients may be AOI systems that can invoke the REST APIs. The system(s) may also provide an interactive, web-based user interface for case of use for AOI station operators.

In some instances, the system(s) may configure the applications/services in such a way to consume Intermediate Data Format (IDF) data for describing PCB component information and/or component layouts. For example, the system(s) may include one or more adapter components to convert from non-standard definition formats. In this way, the system(s) may be compatible with many different kinds of end users/systems and broadly accept input data in various different formats. Additionally, although described in the context of PCB defect detection and PCB-related technologies, the techniques disclosed herein may be applied to a number of different contexts. For instance, the disclosed system(s) may be extended to any manufacturing context, assembly line products (e.g., soda cans, bottles, packaging products, etc.).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs) or vision language models (VLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

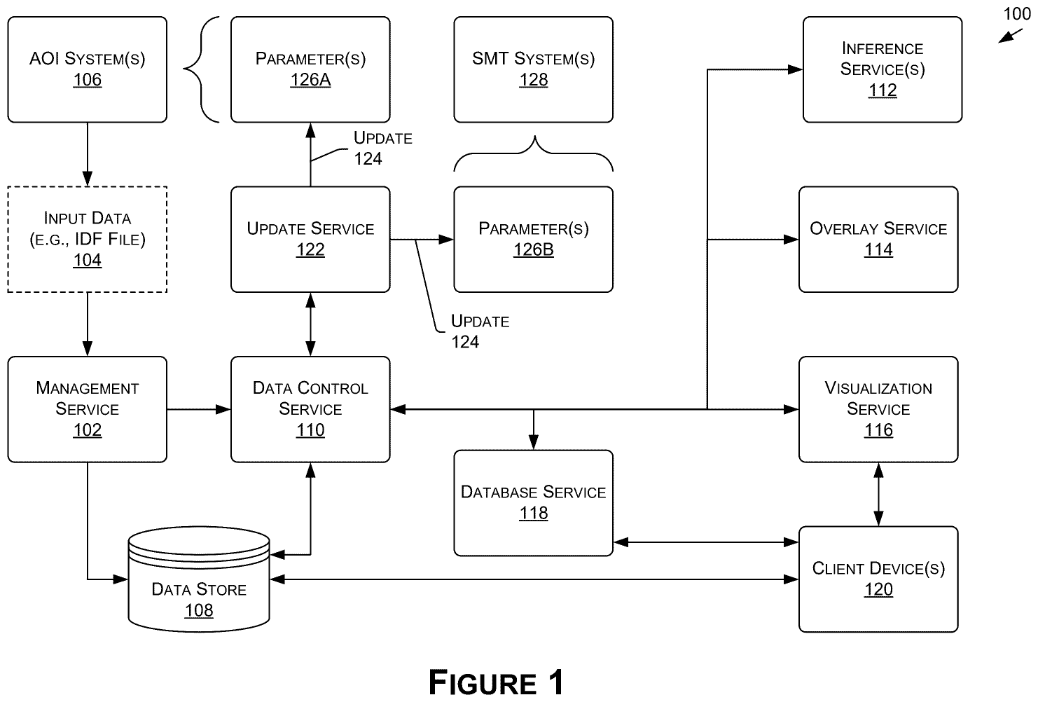

With reference to FIG. 1, FIG. 1 is a data flow diagram illustrating an example process 100 that may be performed by a microservice-based PCB inspection system, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a management service 102 obtaining input data 104 from one or more AOI systems 106. The management service 102 may store the input data 104 in a data store 108 and notify a data control service 110, which may then obtain the input data 104 from the data store 108. The data control service 110 may communicate with one or more inference service(s) 112 to make predictions based on the input data 104. The data control service 110 may also communicate with an overlay service 114 to generate visualization data based on the predictions. The data control service 110 may forward the predictions and/or visualization data to a visualization service 116 and/or a database service 118, which may be accessible to one or more client devices 120 to view the predictions and/or visualizations. An update service 122 may also use the predictions and/or the visualization data to update 124 one or more parameters 126A and/or 126B associated with the AOI system(s) 106 and one or more SMT systems 128, respectively.

In various examples, the services and components of the process 100, such as the management service 102, the data store 108, the control service 110, the inference service(s) 112, the overlay service 114, the visualization service 116, the database service 118, and the update service 122 may be services or components of an application. The application may be used as a secondary inspection system to the AOI system(s) 106. Additionally, or alternatively, the application may be used as an independent, standalone PCB inspection system for analyzing PCB defects for PCBs outside of the manufacturing context.

In some examples, the services and components of the process 100, such as the management service 102, the data store 108, the control service 110, the inference service(s) 112, the overlay service 114, the visualization service 116, the database service 118, and the update service 122 may be independently deployable services (e.g., microservices). For instance, one or more of the management service 102, the data store 108, the control service 110, the inference service(s) 112, the overlay service 114, the visualization service 116, the database service 118, and/or the update service 122 may be packaged along with their runtime environments, dependencies, libraries, and configuration files into a container image that includes everything needed to run the services consistently across different environments. The containerized microservices may be deployed onto one or more container orchestration platforms that manage the lifecycle of the containers, including deployment, scaling, and/or monitoring. Additionally, or alternatively, various other infrastructure types may be used to deploy the management service 102, the data store 108, the control service 110, the inference service(s) 112, the overlay service 114, the visualization service 116, the database service 118, and/or the update service 122. For instance, these services/components may be deployed using virtual machines, serverless computing platforms, Platform-as-a-Service (PaaS) systems, on-prem and/or cloud-delivered computing devices (e.g., traditional hosts), edge computing platforms, a combination thereof, or any other infrastructure systems in addition to containers, or in the alternative thereof.

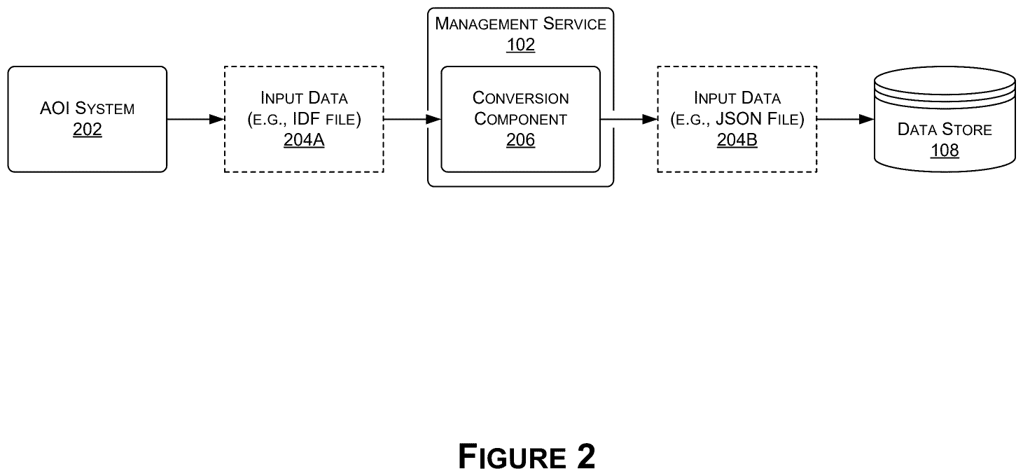

In some instances, the management service 102 may manage the input data 104 that is uploaded to the system for analysis. The management service 102 may provide support for uploading and/or downloading the input data 104 to/from the system. For instance, FIG. 2 illustrates an example of the PCB inspection system converting input data into a desired format, in accordance with some embodiments of the present disclosure. As shown in the example of FIG. 2, an AOI system 202 (which may correspond to the AOI system(s) 106) may upload input data 204A (e.g., an IDF file) to the management service 102. For instance, the input data 204A may include image data representing an image of at least a portion of a PCB. In some instances, the input data 204A may include a crop of an image that corresponds to a predicted defect of the PCB. That is, if the AOI system 202 determines the PCB includes a defective component, the input data 204A may include an image that is cropped around the defective component instead of a complete image of the PCB. Because the input data 204A is in the IDF file format, the management service 102 may use a conversion component 208 to convert the input data 204A from the IDF format into the input data 204B of a JSON format. While IDF and JSON are just examples of file formats the conversion component 208 may convert between, it should be understood that the conversion component 208 may be configured to convert between any number of different format types. The management service 102 may then store the input data 204B of the JSON format in the data store 108.

Referring back to the example of FIG. 1, the management service 102 may additionally support aging policies to manage disk space occupied by the data (e.g., in the data store 108), as well as support retrieval of images containing visualizations of inspection results, among other things. The management service 102 may store the data used and/or generated by the various services in the data store 108. As described herein, this data that is stored in the data store 108 may include, among other things, image data representing images of PCBs, cropped images of PCB defects (e.g., an image of a portion of the PCB), images of PCB components, or any other images. Additionally, the data may include textual data indicating, for instance, information associated with a PCB and/or the image data—such as a serial number or other identifier associated with the PCB, whether the PCB is in the manufacturing or post-manufacturing context, etc.—information associated with an ROI machine that pre-inspected the PCB, information associated with the manufacturing process of the PCB, such as SMT machine or other assembly equipment information. The data store 108 may also store inspection results and metrics determined by the various services.

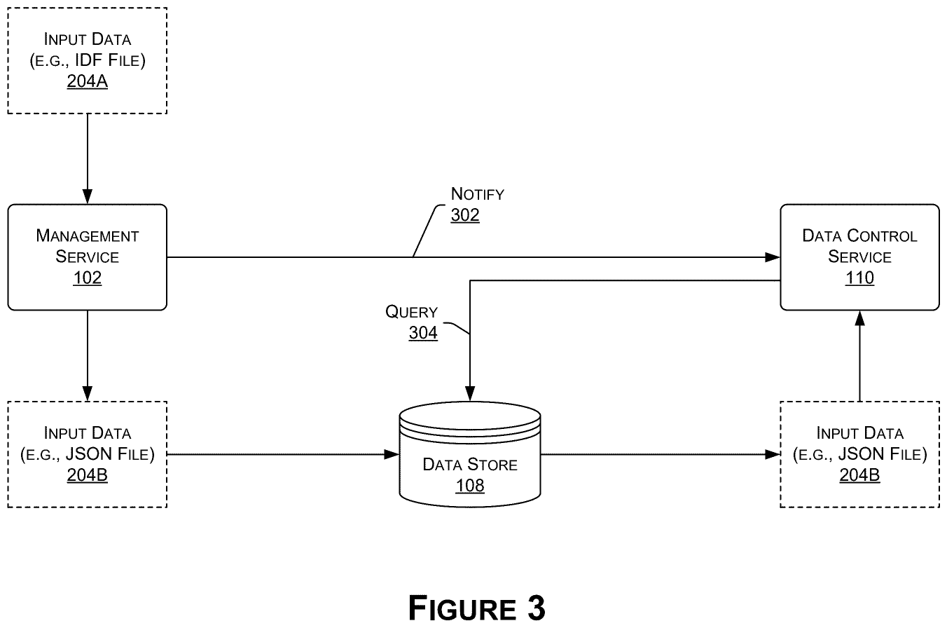

The process 100 may also include the management service 102 storing the input data 104 in the data store 108 and notifying the data control service 110 to obtain the input data 104 from the data store 108. For instance, FIG. 3 illustrates an example of the data control service 110 obtaining input data stored in the data store 108 by the management service 102, in accordance with some embodiments of the present disclosure. As described above and herein, the management service 102 may obtain the input data 204A in the first format (e.g., IDF) and convert it to the input data 204B of the second format. The management service 102 may then store the input data 204B of the second format in the data store 108. The management service 102 may also notify 302 the data control service 110 that the input data 204B has been stored and is ready for processing. On its own schedule, in some instances, the data control service 110 may query 304 the data store 108 based at least on the notification, and the data store 108 may provide the input data 204B of the second format to the data control service 110.

Referring back to the example of FIG. 1, the process 100 may include the data control service 110 sending one or more inference requests to the inference service(s) 112. The inference request(s) may be sent by the data control service 110 responsive to at least one of receiving an indication from the management service 102 that new input data is available or the data control service 110 obtaining the input data 104 from the data store 108. The data control service 110 may send the inference request(s) to the inference service(s) 112 and/or apply the input data 104 to the inference service(s) 112 so that the inference service(s) 112 may analyze the input data 104 and make predictions relating to PCB defects, etc. The data control service 110 may send inference requests to a number of the inference service(s) 112 to perform various types of inspections, and then receive various predictions from the inference service(s) 112 in return.

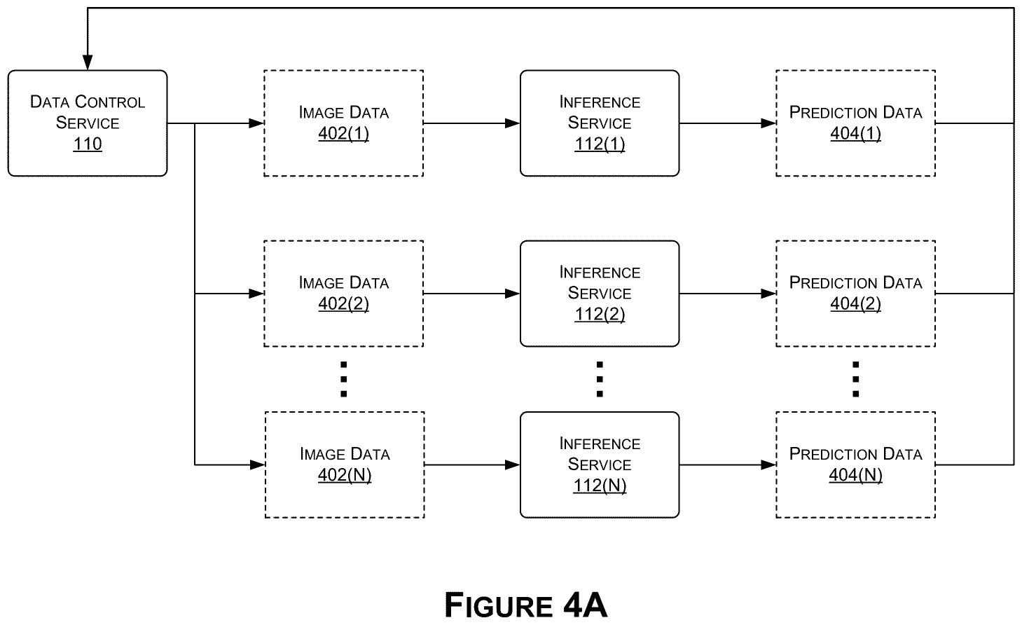

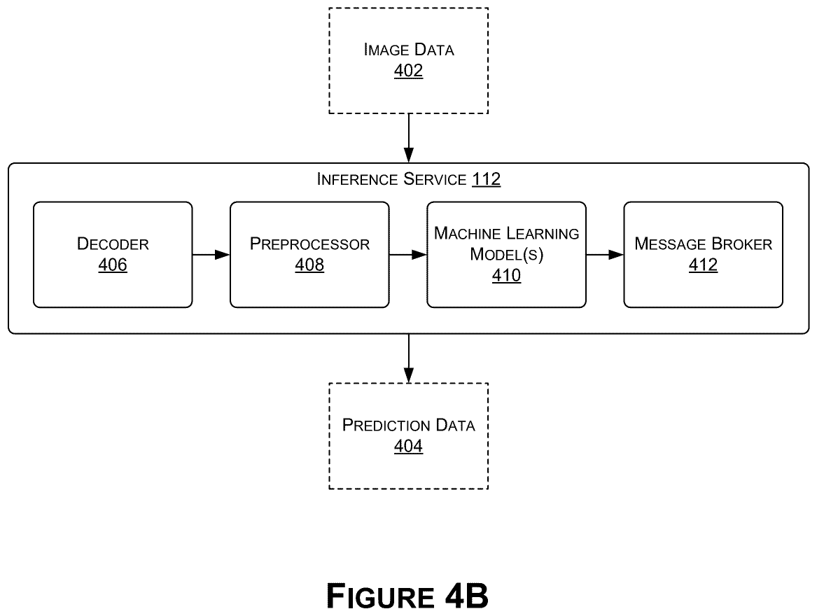

For instance, FIG. 4A illustrates an example of the data control service 110 applying image data 402(1)-402(N) to multiple inference services 112(1)-112(N), in accordance with some embodiments of the present disclosure. For instance, the data control service may apply first image data 402(1) to a first inference service 112(1), apply second image data 402(2) to a second inference service 112(2), and so forth (e.g., apply nth image data 402(N) to an nth inference service 112(N), wherein “N” may represent any number). In some examples, the first image data 402(1) and the second image data 402(2) may be the same or different image data. That is, in some instances the first image data 402(1) may represent one image and the second image data 402(2) may represent another image, or the first image data 402(1) and the second image data 402(2) may represent the same image.

In some examples, the first inference service 112(1) may be configured to predict a first type of PCB-related defect, the second inference service 112(2) may be configured to predict a second type of PCB-related defect, and so forth. For instance, the first inference service 112(1) may include one or more first machine learning models trained to detect wrong component errors, the second inference service 112(2) may include one or more second machine learning models trained to detect missing component errors, and so forth. Additionally, in at least some examples, a machine learning model(s) running on the inference services 112 may be user-defined and/or client specific. That is, the machine learning model(s) may be specially trained to detect certain defects for specific PCBs. Although depicted and described in the example of FIG. 4A as being individual services each running their own specific models, the inference services 112 may be a single service running multiple different models for detecting different types of defects.

In some examples, the inference services 112 may analyze the image data 402 and generate various predictions, which may be represented using prediction data 404(1)-404(N). For instance, the first inference service 112(1) may process the first image data 402(1) and generate the first prediction data 404(1), the second inference service 112(2) may process the second image data 402(2) and generate the second prediction data 404(2), and so forth. As described above and herein, the different inference services 112 may generate different predictions based on how the models of the inference services 112 are trained. As an example, the first prediction data 404(1) may represent predictions relating to incorrect PCB components (e.g., PCB includes component A instead of component B), the second prediction data 404(2) may represent predictions relating to missing PCB components (e.g., a component, such as a processor, resistor, capacitor, gate, memory, etc., missing from the PCB), and so forth. Other predictions relating to PCB defects may include, but are not limited to, component placement defects, misaligned components, defective components, incorrect components, missing components, soldering defects, steel surface defects, plating defects, structural defects, warpage defects, residual defects, or any other visibly observable defects.

In some examples, the inference service(s) 112 may include various components, models, algorithms, and other features for processing the image data 402 and making predictions. For instance, FIG. 4B illustrates an example of the inference service 112 processing the image data 402 to generate predictions represented using the prediction data 404, in accordance with some embodiments of the present disclosure. As shown, the inference service 112 may include a decoder 406, a preprocessor 408, one or more machine learning models 410, and a message broker 412. As such, the inference service 112 may receive the image data 402 (or data corresponding to the image data 402) and decode the data using the decoder 406. The inference service 112 may preprocess the decoded data using the preprocessor 408, and then apply the preprocessed data to the machine learning model(s) 410. Outputs of the machine learning model(s) 410, such as the predictions represented using the prediction data 404, may be communicated using the message broker 412. For instance, the message broker 412 may send the prediction data 404 to the data control service 110 and/or to other services associated with the application. While these are just a couple examples of how the inference service(s) 112 may process image data to generate predictions regarding PCB defects, in other examples, the inference service(s) 112 may use any number of different techniques, models, algorithms, etc. to process the image data and generate predictions about PCB defects.

Referring back to the example of FIG. 1, the process 100 may include the data control service 110 communicating with the overlay service 114 to generate visualizations based on the predictions. For instance, the data control service 110 may send requests to the overlay service 114 to generate visualizations (e.g., images, graphs, statistics, etc.) associated with predictions made using the inference service(s) 112. The data control service 110 may also manage the state of the various inference requests in the data store 108 and/or save inference results in the data store 108 so that the results may be queried later. Based at least on the visualization requests, the overlay service 114 may visualize the results of inference (e.g., the predictions representing using the prediction data 404).

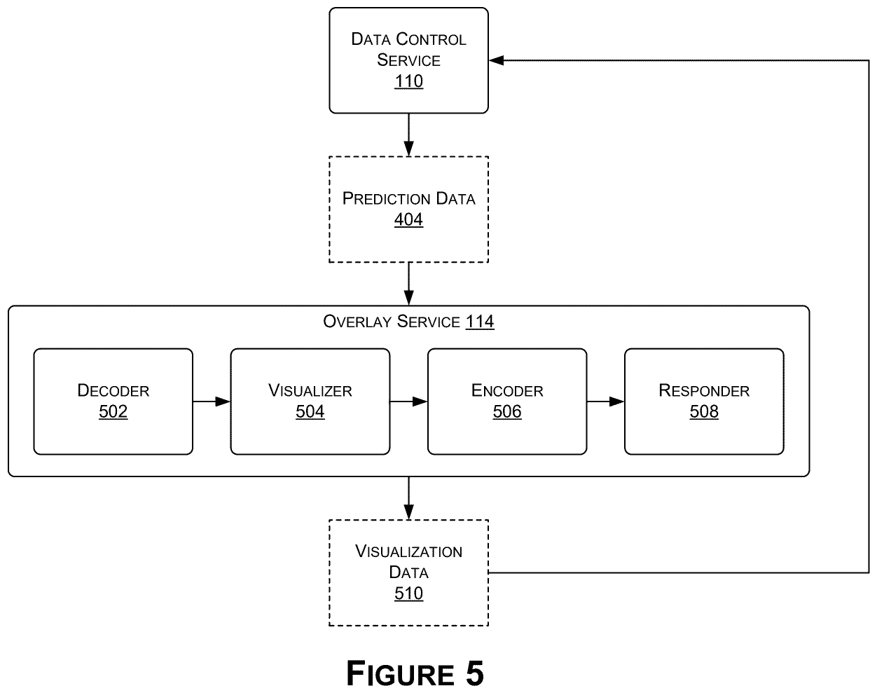

For instance, FIG. 5 illustrates an example of the overlay service 114 generating a visualization based on predictions, in accordance with some embodiments of the present disclosure. As shown, in the example of FIG. 5, the overlay service 114 may include various components, such as a decoder 502, a visualizer 504, an encoder 506, and a responder 508. In some examples, the data control service 110 may send the prediction data 404 to the overlay service 114 within a request for the overlay service 114 to generate a visualization using the prediction data 404. In some instances, the prediction data 404 may be encoded by the data control service 110 in order to be send to the overlay service 114. As such, the overlay service 114 may use the decoder 502 to decode the prediction data 404.

The overlay service 114 may then user the visualizer 504 to generate the visualization data 510. In some instances, the visualization data 510 may indicate information associated with the one or more predicted defects associated with the PCB. In at least some examples, the visualizer 504 may modify or update the original image data 402 to draw (indicate, etc.) locations of defects and/or provide (include, etc.) descriptive text on the image of the PCB. For instance, if a defect is detected for a specific component of multiple components of the PCB, the image of the PCB may be modified with a box, arrow, or some other visual indicator to indicate the location of the specific component that is defective. Additionally, or alternatively, the visualizer 504 may modify the image of the PCB to include textual data describing the defect (e.g., that the defect is a solder defect, a wrong component, a misalignment, a component failure, etc.). Additionally, or alternatively, the visualization data 510 generated by the visualizer 504 may include visualizations of metrics based on the prediction data 404. Such visualizations of metrics may include charts, graphs, tables, textual data, or any other data for visually conveying the metrics. The metrics may include a number of defects detected by the system per second, a running total of defects for a certain model of PCB, a running total of defects for a certain component used on PCBs, metrics associated with an AOI system (e.g., number of false-positives or false-negatives, etc.), metrics associated with a SMT machine (e.g., number of defects per PCB produced), or any other metrics.

In some examples, the overlay service 114 may use the encoder 506 to encode the visualization data 510. For instance, the visualization data 510 may need to be encoded in order to be sent back to the data control service 110, and the encoder 506 may be used to perform this encoding. In some examples, the responder 508 may then send the encoded visualization data 510 to the data control service 110. In some examples, the visualization data 510 may correspond to a JSON overlay response. While these are just a couple examples of how the overlay service 114 may process inference results (e.g., the prediction data 404) to generate visualizations, in other examples, the overlay service 114 may use any number of different techniques to process the inference results and generate visualizations.

Referring back to the example of FIG. 1, the process 100 may also include the data control service 110 forwarding the predictions and/or visualizations to the visualization service 116 and/or the database service 118. The visualization service 116 may be accessible to the client device(s) 120 to view the predictions and/or visualizations using a graphical user interface. The visualization service 116 may use one or more dashboards to present a user interface indicating results of the inference, visualizations, or any other data that may be stored in the data store 108 of the system. For instance, the visualization service 116 may generate a graphical user interface to visualize various defects of individual PCBs. Additionally, or alternatively, the visualization service 116 may generate a graphical user interface to visualize various metrics associated with the defects, such as number of defects second, average defects per PCB, distribution of various kinds of defects, PCB models with highest number of defects, frequencies of defect types per PCB, or any other metrics. The metrics may be visualized by the visualization service 116 using charts, graphs, images, text, text-to-speech, or any other means of conveying the information.

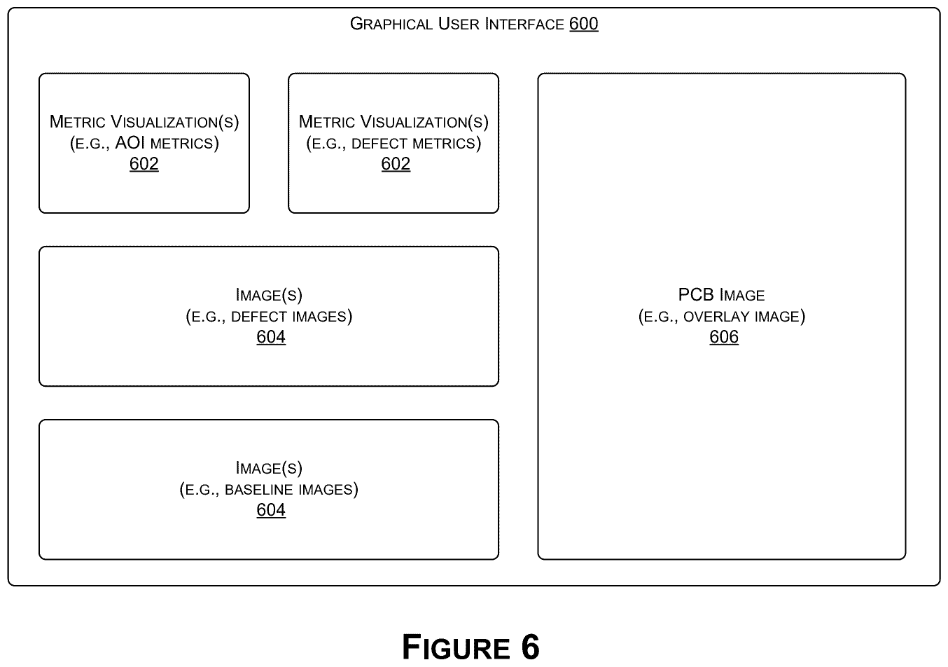

For instance, FIG. 6 illustrates example detail (e.g., a layout) of a graphical user interface 600 that may be generated to display information associated with PCB defects, in accordance with some embodiments of the present disclosure. In some examples, the graphical user interface 600 may include one or more metric visualizations 602, one or more images 604, a PCB image 606, or any other visualizations described herein. However, this is just an example, and the graphical user interface 600 may include other data in addition to, or in the alternative of, the metric visualization(s) 602, the image(s) 604, and the PCB image 606. The metric visualization(s) 602 may include metrics related to an AOI system, metrics related to PCB defects, metrics related to SMT machines, among other metrics. The metric visualizations 602 may include charts, graphs, tables, comparisons, textual information, numerical information, images, or any other data for visually conveying metric information. The image(s) 604 may include images of defects, baseline images, or any other images. As an example, if a component is defective or incorrect, one of the images may correspond to the incorrect or defective component, while another image may correspond to the correct or operative component. The graphical user interface 600 may also include a PCB image 606. For instance, the PCB image 606 may include a modified version of an original image of a PCB, the original image modified (e.g., overlayed) to include information about the PCB defect. For instance, the PCB image 606 may include the image applied to the inference service but updated to indicate the defective portion of the PCB, what the defect is, which component(s) is involved in the defect, or any other information.

Referring back to the example of FIG. 1, the process 100 may also include the update service 122 using the predictions, visualizations, metrics, and/or any other information generated by the system(s) to update 124 one or more parameters 126A and/or 126B associated with the AOI system(s) 106 and the SMT system(s) 128, respectively. For instance, the update service 122 may use one or more of the predictions, the visualizations, and/or the metrics to identify errors associated with the AOI system(s) 106, the SMT system(s) 128, and/or any other systems. As an example, based at least on metrics indicating the AOI system(s) 106 is producing a number of false-positive or false-negative detections that meets or exceeds a threshold, the update service 122 may alter the parameter(s) 126A associated with the AOI system(s) 106 to improve its performance and reduce the number of misdetections. As another example, based at least on visualizations and metrics indicating that PCBs produced by the SMT system(s) 128 includes a number of defects that meet or exceed a threshold, the update service 122 may alter the parameter(s) 126B of the SMT system(s) 128 to improve its performance, temporarily shut down the SMT system(s) 128, or perform any other operation responsive to the defects. As yet another example, if metrics continuously indicate a failure of a certain component of a PCB that is in market, the update service 122 may propose changes or alternative components to replace the problematic components. These proposed changes may be sent to the client device(s) 120, in at least one example. While these are just a few examples, the update service 122 may perform any number and/or type of operations to improve PCB-related technology based on detecting and analyzing PCB defects.

The database service 118 may store one or more use-case specific database tables. In some examples, the data control service 110 and/or the database service 118 itself may update the use-case specific database tables based on results from inference, visualizations based on the results of inference, or any other data generated by the system. The database service 118 may include one or more database servers that perform one or more operations on behalf of the database service 118, such as interacting with one or more external databases.

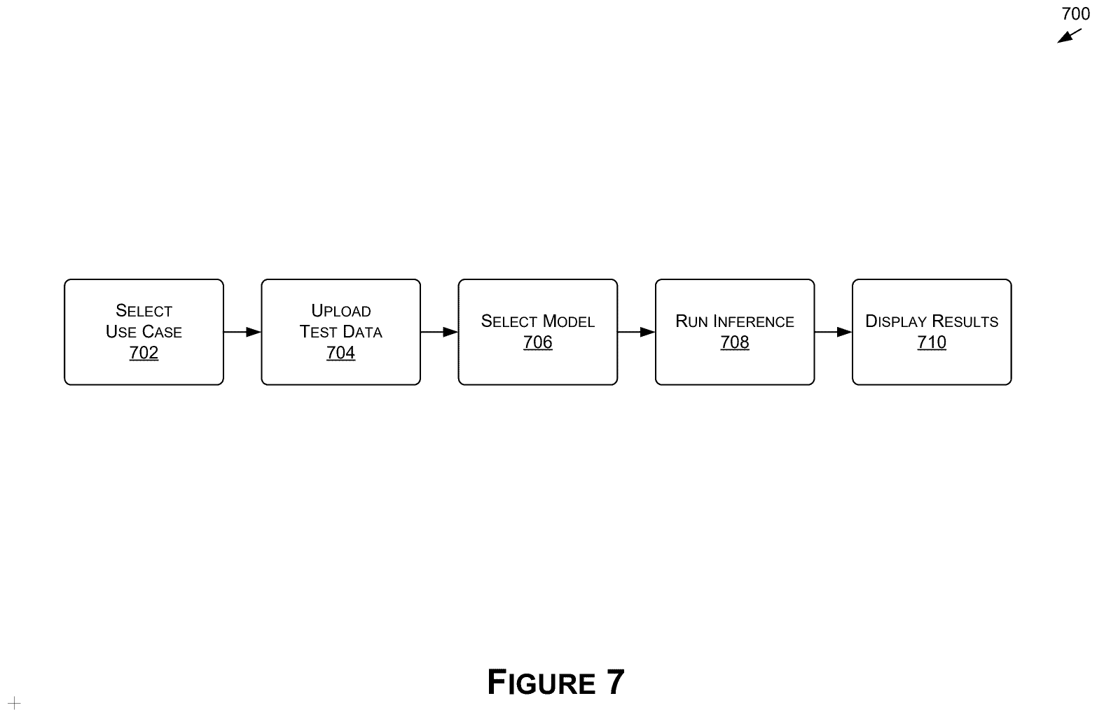

Referring now to FIG. 7, FIG. 7 is data flow diagram illustrating an example end-to-end process 700 associated with inspecting a PCB for defects, in accordance with some embodiments of the present disclosure. At operation 702, the process 700 may include selecting a use case for analyzing a defect associated with a PCB. For instance, input may be received from a client device (e.g., via a graphical user interface) that is accessing the application. The input may indicate that an inference service/model is to be invoked for inspecting whether a PCB has a certain type of defect. For example, the input may indicate whether a missing component inspection is to be performed, an incorrect component inspection is to be performed, a misaligned component inspection is to be performed, a soldering defect inspection is to be performed, etc.

At operation 704, the process 700 may include uploading test data. For instance, test data (also referred to herein as “input data”) may be uploaded by the client device to the application via the graphical user interface. In some examples, the test data may include image data representing one or more images of a PCB. The image(s) of the PCB may depict the entire PCB or portions of the PCB. In some examples, the test data may be uploaded to the application and then stored in a database associated with the application. Then, when an inspection is requested, the applications may retrieve the necessary data from the database.

At operation 706, the process 700 may include selecting a model for inference. For instance, input data may be received via the user interface indicating a specific model that is to be used for detecting the defects associated with the PCB depicted in the uploaded test data. In some instances, client specific models may be selected that are optimized for identifying certain types of defects. For instance, the client device may provide input specifying a name of the model to be used, a version of the model to be used, a file for the model, a key associated with the model, and/or other parameters.

At operation 708, the process 700 may include running the inference on the test data using the selected model. For instance, the test data (e.g., image data) may be applied to the selected model, and the model may generate one or more predictions relating to defects associated with the PCB depicted in the test data. In some examples, the model may be a deep neural network, a convolutional neural network, or any other type of neural network. Although examples are described herein with respect to using neural networks in machine learning models, this is not intended to be limiting. For example, and without limitation, any of the various machine learning models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

At operation 710, the process 700 may include displaying the results of inference. For instance, the results may be presented on a display of the client device via a user interface. That is, the display may be displaying the user interface, and the results may be displayed on the user interface. In some examples, the results may include the visualizations described herein, such as an image of a PCB that is overlayed with information related to the defects. Additionally, or alternatively, the results may include visualizations of metrics associated with the PCB defects.

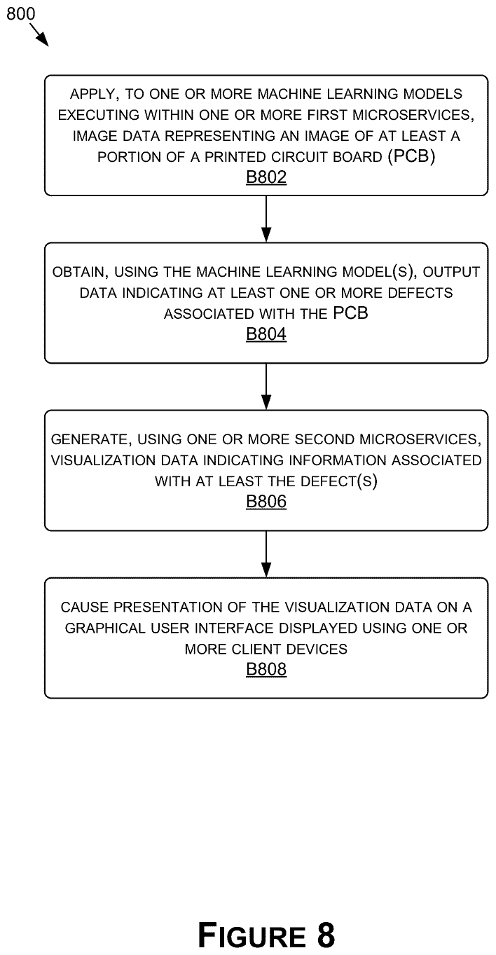

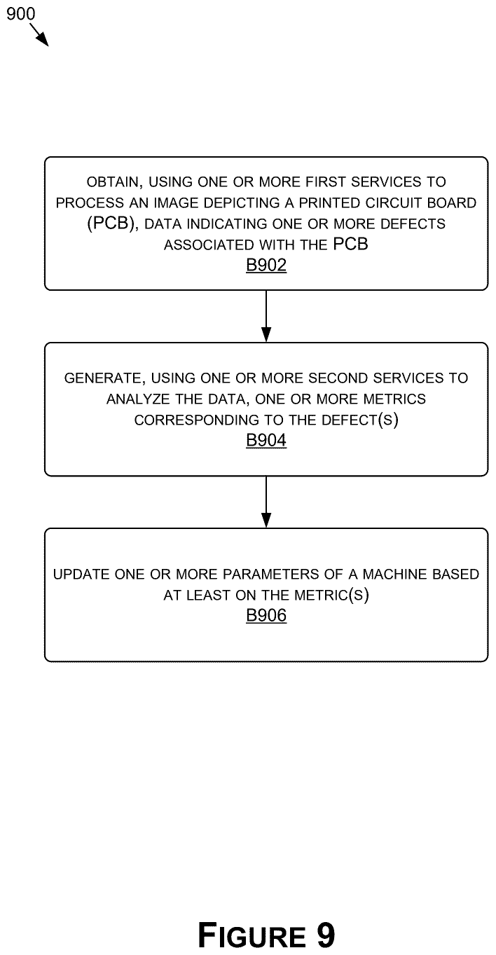

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 800 and 900 are described, by way of example, with respect to the system of FIG. 1. However, this method may additionally or alternatively be executed by any one system, or any combination of systems, including, but not limited to, those described herein.

FIG. 8 is a flow diagram illustrating an example method 800 for using a microservice-based architecture to analyze and display information relating to PCB defects, in accordance with some embodiments of the present disclosure. The method 800, at block B802, includes applying, to one or more machine learning models executing within one or more first microservices, image data representing an image of at least a portion of a PCB. For instance, the data control service 110 may send the image data to the inference service(s) 112. The inference service(s) 112 may include the machine learning model(s), and the machine learning model(s) may process the image data representing the image of the portion of the PCB.

The method 800, at block B804, includes obtaining, using the machine learning model(s), output data indicating at least one or more defects associated with the PCB. For instance, the data control service 110 may obtain the output data indicating the defect(s) associated with the PCB from the inference service(s) 112. In some instances, the output data may include multiple instances of output data obtained from multiple instances of the inference service(s) 112, where each inference service of the inference services 112 is configured to predict a different type of PCB defect.

The method 800, at block B806, includes generating, using one or more second microservices, visualization data indicating information associated with at least the one or more defects. For instance, the data control service 110 may send the output data to the overlay service 114 and/or the visualization service 116. The overlay service 114 and/or the visualization service 116 may generate the visualization data indicating the information associated with the defect(s). The visualization data may represent visualizations associated with the defect(s). For instance, the visualizations may include the image overlaid with information (e.g., bounding shapes, indicators, textual information, etc.) related to the defect(s), metrics related to the defect(s), and/or any other visualizations described herein.

The method 800, at block B808, includes causing presentation of the visualization data on a graphical user interface displayed using one or more client devices. For instance, the visualization service 116 may cause presentation of the visualization data on the graphical user interface displayed using the client device(s) 120. As described herein, the graphical user interface may display one or more visualizations represented by the visualization data. The visualizations may include visualizations of metrics related to PCB defects, visualizations of the PCB defects themselves, visualizations of an ideal state of the PCB, or any other visualizations for visually conveying information related to the PCB defects.

FIG. 9 is a flow diagram illustrating an example method for updating parameters of a machine based on PCB defects, in accordance with some embodiments of the present disclosure. The method 900, at block B902, includes obtaining, using one or more first services to process an image depicting a PCB, data indicating one or more defects associated with the PCB. For instance, the data control service 110 may obtain the data indicating the defect(s) associated with the PCB using the inference service(s) 112 to process the image depicting the PCB. In some examples, the data control service 110 may apply the image depicting the PCB to the inference service(s) 112. The image may, in some examples, depict the entire PCB or depict a portion of the PCB (e.g., a cropped image corresponding to an area of the PCB deemed as defective by an AOI system).

The method 900, at block B904, includes generating, using one or more second services to analyze the data, one or more metrics corresponding to the one or more defects. For instance, the data control service 110 may use the overlay service 114 and/or the visualization service 116 to analyze the data and generate the metric(s) corresponding to the defect(s). In some examples, visualizations of the metrics may also be generated. Such visualizations may include charts, graphs, tables, textual data, or any other data for visually conveying the metrics. The metrics may include a number of defects detected by the system per second, a running total of defects for a certain model of PCB, a running total of defects for a certain component used on PCBs, metrics associated with an AOI system (e.g., number of false-positives or false-negatives, etc.), metrics associated with a SMT machine (e.g., number of defects per PCB produced), or any other metrics.

The method 900, at block B906, includes updating one or more parameters of a machine based at least on the one or more metrics. For instance, the update service 122 may update the parameter(s) 126A and/or 126B associated with the AOI system(s) 106 and the SMT system(s) 128, respectively, based at least on the one or more metrics. For instance, the update service 122 may use one or more of the predictions, the visualizations, and/or the metrics to identify errors associated with the AOI system(s) 106, the SMT system(s) 128, and/or any other systems. As an example, based at least on metrics indicating the AOI system(s) 106 is producing a number of false-positive or false-negative detections that meets or exceeds a threshold, the update service 122 may alter the parameter(s) 126A associated with the AOI system(s) 106 to improve its performance and reduce the number of misdetections. As another example, based at least on visualizations and metrics indicating that PCBs produced by the SMT system(s) 128 includes a number of defects that meet or exceed a threshold, the update service 122 may alter the parameter(s) 126B of the SMT system(s) 128 to improve its performance, temporarily shut down the SMT system(s) 128, or perform any other operation responsive to the defects. As yet another example, if metrics continuously indicate a failure of a certain component of a PCB that is in market, the update service 122 may propose changes or alternative components to replace the problematic components.

### Example Computing Device

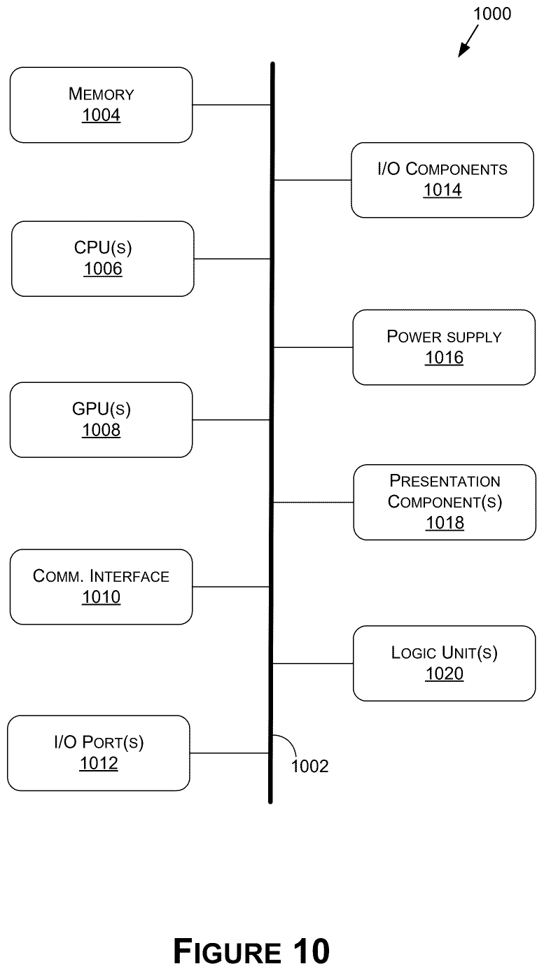

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per sc.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

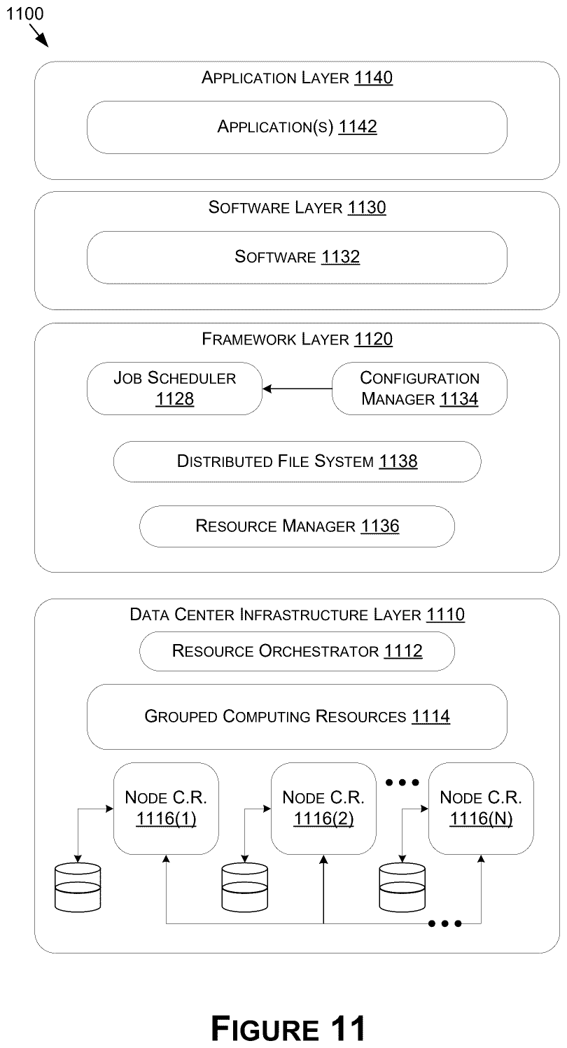

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: applying, to one or more machine learning models executed using one or more first microservices, image data representing an image of at least a portion of a printed circuit board (PCB); obtaining, using the one or more machine learning models, output data indicating at least one or more defects associated with the PCB; generating, using one or more second microservices, visualization data indicating information associated with at least the one or more defects; and causing presentation of the visualization data on a graphical user interface displayed using one or more client devices.

B. The method as recited in paragraph A, further comprising: comparing, using one or more third microservices, the one or more defects associated with the PCB with one or more predicted defects associated with the PCB to determine one or more differences between the one or more defects and the one or more predicted defects, the one or more predicted defects determined using one or more Automated Optical Inspection (AOI) systems to analyze the PCB; and updating one or more parameters associated with the one or more AOI systems based at least on the one or more differences between the one or more defects and the one or more predicted defects.

C. The method as recited in any one of paragraphs A-B, wherein the at least the portion of the PCB depicted in the image corresponds to one or more predicted defects associated with the PCB, the one or more predicted defects determined using one or more Automated Optical Inspection (AOI) machines.

D. The method as recited in any one of paragraphs A-C, wherein the applying of the image data to the one or more machine learning models comprises sending, from one or more third microservices, at least the image data to the one or more first microservices.

E. The method as recited in any one of paragraphs A-D, further comprising storing, using one or more third microservices, at least one of the output data or the visualization data in a database accessible to the one or more third microservices.

F. The method as recited in any one of paragraphs A-E, further comprising: applying, to one or more second machine learning models executed using the one or more first microservices, second image data representing a second image of at least a second portion of the PCB; and obtaining, using the one or more second machine learning models, second output data indicating at least one or more second defects associated with the PCB.

G. The method as recited in any one of paragraphs A-F, wherein the one or more second machine learning models are trained to predict a different type of PCB defect than the one or more machine learning models.

H. The method as recited in any one of paragraphs A-G, wherein the visualization data is further indicative of one or more metrics, the one or more metrics having one or more values calculated based at least on the one or more defects associated with the PCB.

I. The method as recited in any one of paragraphs A-H, wherein the one or more machine learning models execute on one or more resources associated with one or more nodes hosting one or more containers associated with the one or more first microservices.

J. The method as recited in any one of paragraphs A-I, wherein the one or more defects associated with the PCB include at least one of: one or more defective components; one or more incorrect components; one or more missing components; one or more soldering defects; one or more plating defects; one or more component placement defects; one or more warpage defects; or one or more residual defects.

K. The method as recited in any one of paragraphs A-J, wherein the output data further indicates at least one or more confidence scores corresponding to the one or more defects associated with the PCB, and the visualization data further indicates second information associated with the one or more confidence scores.

L. A system comprising: one or more processors to: obtain, using one or more first services to process one or more images depicting one or more printed circuit boards (PCBs), data indicating one or more defects associated with the one or more PCBs; generate, using one or more second services to analyze the data, one or more metrics corresponding to the one or more defects; and update one or more parameters of one or more machines based at least on the one or more metrics.

M. The system as recited in paragraph L, wherein the one or more defects associated with the one or more PCBs include at least one of: one or more defective components; one or more component placement defects; one or more incorrect components; one or more missing components; one or more soldering defects; one or more plating defects; one or more warpage defects; or one or more residual defects.

N. The system as recited in any one of paragraphs L-M, wherein the one or more first services correspond to one or more containerized microservices running one or more machine learning models, the one or more defects associated with the one or more PCBs obtained based at least on applying, to the one or more machine learning models, image data representing the one or more images.

O. The system as recited in any one of paragraphs L-N, the one or more processors further to: determine, based at least on the one or more metrics, that one or more differences between the one or more defects and one or more predicted defects associated with the one or more PCBs meet or exceed a threshold, the one or more predicted defects obtained using one or more automated optical inspection (AOI) machines to inspect the one or more PCBs; and update one or more second parameters of the one or more AOI machines based at least on the one or more differences meeting or exceeding the threshold.

P. The system as recited in any one of paragraphs L-O, the one or more processors further to: identify at least one machine of the one or more machines that contributed to manufacturing a number of the one or more PCBs; determine, based at least on the one or more metrics, that a subset of the one or more defects associated with the number of the one or more PCBs meets or exceeds a threshold; and update one or more second parameters of the machine based at least on the subset of the one or more defects meeting or exceeding the threshold.

Q. The system as recited in any one of paragraphs L-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. At least one processor comprising: processing circuitry to update one or more parameters of an Automated Optical Inspection (AOI) machine based at least on a determination that a number of incorrect predictions of the AOI machine meets or exceeds a threshold, the number of incorrect predictions determined based at least on a number of defects associated with a printed circuit board (PCB), the number of the defects detected using one or more machine learning models to process image data used by the AOI machine to generate the incorrect predictions.

S. The processor as recited in paragraph R, wherein the determination that the number of incorrect predictions of the AOI machine meets or exceeds the threshold is based at least on computing one or more metrics corresponding to at least the defects detected using the one or more machine learning models and one or more predicted defects of the AOI machine, the one or more predicted defects including the incorrect predictions.

T. The processor as recited in any one of paragraphs R-S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
applying, to one or more machine learning models executed using one or more first microservices, image data representing an image of at least a portion of a printed circuit board (PCB);
obtaining, using the one or more machine learning models, output data indicating at least one or more defects associated with the PCB;
generating, using one or more second microservices, visualization data indicating information associated with at least the one or more defects; and
causing presentation of the visualization data on a graphical user interface displayed using one or more client devices.

2. The method of claim 1, further comprising:
comparing, using one or more third microservices, the one or more defects associated with the PCB with one or more predicted defects associated with the PCB to determine one or more differences between the one or more defects and the one or more predicted defects, the one or more predicted defects determined using one or more Automated Optical Inspection (AOI) systems to analyze the PCB; and
updating one or more parameters associated with the one or more AOI systems based at least on the one or more differences between the one or more defects and the one or more predicted defects.

3. The method of claim 1, wherein the at least the portion of the PCB depicted in the image corresponds to one or more predicted defects associated with the PCB, the one or more predicted defects determined using one or more Automated Optical Inspection (AOI) machines.

4. The method of claim 1, wherein the applying of the image data to the one or more machine learning models comprises sending, from one or more third microservices, at least the image data to the one or more first microservices.

5. The method of claim 1, further comprising storing, using one or more third microservices, at least one of the output data or the visualization data in a database accessible to the one or more third microservices.

6. The method of claim 1, further comprising:
applying, to one or more second machine learning models executed using the one or more first microservices, second image data representing a second image of at least a second portion of the PCB; and
obtaining, using the one or more second machine learning models, second output data indicating at least one or more second defects associated with the PCB.

7. The method of claim 6, wherein the one or more second machine learning models are trained to predict a different type of PCB defect than the one or more machine learning models.

8. The method of claim 1, wherein the visualization data is further indicative of one or more metrics, the one or more metrics having one or more values calculated based at least on the one or more defects associated with the PCB.

9. The method of claim 1, wherein the one or more machine learning models execute on one or more resources associated with one or more nodes hosting one or more containers associated with the one or more first microservices.

10. The method of claim 1, wherein the one or more defects associated with the PCB include at least one of:
one or more defective components;
one or more incorrect components;
one or more missing components;
one or more soldering defects;
one or more plating defects;
one or more component placement defects;
one or more warpage defects; or
one or more residual defects.

11. The method of claim 1, wherein the output data further indicates at least one or more confidence scores corresponding to the one or more defects associated with the PCB, and the visualization data further indicates second information associated with the one or more confidence scores.

12. A system comprising:
one or more processors to:
obtain, using one or more first services to process one or more images depicting one or more printed circuit boards (PCBs), data indicating one or more defects associated with the one or more PCBs;
generate, using one or more second services to analyze the data, one or more metrics corresponding to the one or more defects; and
update one or more parameters of one or more machines based at least on the one or more metrics.

13. The system of claim 12, wherein the one or more defects associated with the one or more PCBs include at least one of:
one or more defective components;
one or more component placement defects;
one or more incorrect components;
one or more missing components;
one or more soldering defects;
one or more plating defects;
one or more warpage defects; or
one or more residual defects.

14. The system of claim 12, wherein the one or more first services correspond to one or more containerized microservices running one or more machine learning models, the one or more defects associated with the one or more PCBs obtained based at least on applying, to the one or more machine learning models, image data representing the one or more images.

15. The system of claim 12, the one or more processors further to:
determine, based at least on the one or more metrics, that one or more differences between the one or more defects and one or more predicted defects associated with the one or more PCBs meet or exceed a threshold, the one or more predicted defects obtained using one or more automated optical inspection (AOI) machines to inspect the one or more PCBs; and
update one or more second parameters of the one or more AOI machines based at least on the one or more differences meeting or exceeding the threshold.

16. The system of claim 12, the one or more processors further to:
identify at least one machine of the one or more machines that contributed to manufacturing a number of the one or more PCBs;
determine, based at least on the one or more metrics, that a subset of the one or more defects associated with the number of the one or more PCBs meets or exceeds a threshold; and
update one or more second parameters of the machine based at least on the subset of the one or more defects meeting or exceeding the threshold.

17. The system of claim 12, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. At least one processor comprising:
processing circuitry to update one or more parameters of an Automated Optical Inspection (AOI) machine based at least on a determination that a number of incorrect predictions of the AOI machine meets or exceeds a threshold, the number of incorrect predictions determined based at least on a number of defects associated with a printed circuit board (PCB), the number of the defects detected using one or more machine learning models to process image data used by the AOI machine to generate the incorrect predictions.

19. The processor of claim 18, wherein the determination that the number of incorrect predictions of the AOI machine meets or exceeds the threshold is based at least on computing one or more metrics corresponding to at least the defects detected using the one or more machine learning models and one or more predicted defects of the AOI machine, the one or more predicted defects including the incorrect predictions.

20. The processor of claim 18, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
